(19) United States
(12) Patent Application Publication
(10) Pub. No.: US 2024/0312302 A1
(43) Pub. Date: Sep. 19, 2024

(54) SERVICE PROVIDING SERVER FOR PROVIDING THE GAME SERVICE THAT SUPPORTS PARTICIPATION IN A TOURNAMENT FOR A GAME USING A TICKET AND THAT RECOMMENDS A GAME TO A USER, AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/604,402

(22) Filed: Mar. 13, 2024

(30) Foreign Application Priority Data
Mar. 15, 2023 (KR) 10-2023-0033709

(51) Int. Cl. G07F 17/32; H04L 9/08; H04L 9/32

(52) U.S. Cl. CPC G07F 17/323; G07F 17/3276; H04L 9/0825; H04L 9/3247

(57) ABSTRACT

Disclosed are a service providing server for providing a game service that supports participation in a tournament for a game using a ticket, and recommends a customized game to a user, and the operating method thereof to support members to enjoy a game while competing with other members in a tournament scheme in an online environment, and at the same time, support a member who subscribes in the game service to be recommended with an optimal game according to a preferred genre thereof.

### CROSS-REFERENCE TO RELATED APPLICATIONS

This application claims priority to and the benefit of Korean Patent Application No. 10-2023-0033709 filed in the Korean Intellectual Property Office on Mar. 15, 2023, the entire contents of which are incorporated herein by reference.

### TECHNICAL FIELD

The present disclosure relates to a service providing server for providing the game service that supports participation in a tournament for a game using a ticket and recommends a game to a user, and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others online, in that the electronic terminals enable online connections, and as such an environment is widely distributed, an interest in introduction of a new business model using an online based game is also increasing.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which does not allow anybody to participate in the tournament, but allows only the users who qualify for participating in a predetermined tournament to participate in the tournament to improve the quality of the service.

In addition, in the game service, a function to recommend an appropriate game to each user also needs to be introduced to promote the convenience of game selection of persons who subscribe to the service. However, it is necessary to consider introduction of the service that recommends the game to be customized by considering a preferred game genre of each user when recommending the game to each user in that game genres preferred by the users who subscribe in the game service are different from each other.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game and can recommend a game according to a preferred genre to be customized, with respect to the member who subscribes to a tournament platform service.

### SUMMARY OF THE INVENTION

The present disclosure has been made in an effort to provide a service providing server for providing a game service that supports participation in a tournament for a game using a ticket, and recommends a customized game to a user, and the operating method thereof to support members to enjoy a game while competing with other members in a tournament scheme in an online environment, and at the same time, support a member who subscribes in the game service to be recommended with an optimal game according to a preferred genre thereof.

An exemplary embodiment of the present disclosure provides a service providing server for providing the game service that supports participation in a tournament for a game using a ticket and that recommends a game to a user, which includes: a ticket number information storage unit storing information on the number of required tickets for participating in tournaments of a plurality of predetermined respective games; a ticket quantity information storage unit storing information on the quantity of holding tickets held by each of a plurality of members which subscribes to the game service; a complex information storage unit storing member identification information for each of the plurality of members, and information on a predetermined preferred genre corresponding to each of the plurality of members (the preferred genre of each of the plurality of members means any one genre pre-selected to be a genre preferred by each member among predetermined s (s is a natural number of 3 or more) types of genres; a play history information storage unit storing play history information corresponding to each of the plurality of games, wherein the play history information of each of the plurality of games means information configured by members identification information for each of the members who plays each game once or more; a preferred genre confirmation unit conforming, when a recommendation request instruction of a customized game is received from a first client terminal held by a first member which is any one of the plurality of members, member identification information for each of members who plays each game once or more from the play history information corresponding to each of the plurality of games stored in the play history information storage unit, and then confirming a preferred genre for each of the members who play each game once or more with respect to each of the plurality of games by referring to the complex information storage unit; a selection request message transmission unit confirming a first preferred genre for the first member by referring to the complex information storage unit, and generating and transmitting a selection request message for requesting the first client terminal to select t (t is a natural number of 2 or more or less than s) additional preferred genres for recommending the customized game among the s types of genres to the first client terminal; a recommendation information transmission unit selecting, when information on t first additional preferred genres among the s types of genres is received from the first client terminal in response to the selection request message, at least one first game matched with the first preferred genre and the t first additionally preferred genres among the plurality of games based on the preferred genre for each of the members who play each game once or more, which is confirmed with respect to each of the plurality of games, and then transmitting recommendation information indicating that the at least one first game is a recommendation game for the first member to the first client terminal; a confirmation unit confirming, when an access request command to a tournament session, wherein the tournament session means a session opened for allowing members accessing the tournament session through the client terminal to play the second game online jointly, opened for a second game which is any one of the one or more first games is received from the first client terminal after the recommendation information is transmitted to the first client terminal, certification for the first member is conducted, and then a first required number which is the number of required tickets for participating in the tournament of the second game by referring to the ticket number information storage unit, and confirming the quantity of holding tickets held by the first member by referring to the ticket quantity information storage unit; and a reduction processing unit allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number.

Further, another exemplary embodiment of the present disclosure provides an operating method of a service providing server for providing the game service that supports participation in a tournament for a game using a ticket and that recommends a game to a user, which includes: maintaining a ticket number information storage unit storing information on the number of required tickets for participating in tournaments of a plurality of predetermined respective games; maintaining a ticket quantity information storage unit storing information on the quantity of holding tickets held by each of a plurality of members which subscribes to the game service; maintaining a complex information storage unit storing member identification information for each of the plurality of members, and information on a predetermined preferred genre corresponding to each of the plurality of members (the preferred genre of each of the plurality of members means any one genre pre-selected to be a genre preferred by each member among predetermined s (s is a natural number of 3 or more) types of genres; maintaining a play history information storage unit storing play history information corresponding to each of the plurality of games, wherein the play history information of each of the plurality of games means information configured by members identification information for each of members who plays each game once or more; conforming, when a recommendation request instruction of a customized game is received from a first client terminal held by a first member which is any one of the plurality of members, member identification information for each of members who plays each game once or more from the play history information corresponding to each of the plurality of games stored in the play history information storage unit, and then confirming a preferred genre for each of the members who play each game once or more with respect to each of the plurality of games by referring to the complex information storage unit; confirming a first preferred genre for the first member by referring to the complex information storage unit, and generating and transmitting a selection request message for requesting the first client terminal to select t (t is a natural number of 2 or more or less than s) additional preferred genres for recommending the customized game among the s types of genres to the first client terminal; selecting, when information on t first additional preferred genres among the s types of genres is received from the first client terminal in response to the selection request message, at least one first game matched with the first preferred genre and the t first additionally preferred genres among the plurality of games based on the preferred genre for each of the members who play each game once or more, which is confirmed with respect to each of the plurality of games, and then transmitting recommendation information indicating that the at least one first game is a recommendation game for the first member to the first client terminal; confirming, when an access request command to a tournament session, wherein the tournament session means a session opened for allowing members accessing the tournament session through the client terminal to play the second game online jointly, opened for a second game which is any one of the one or more first games is received from the first client terminal after the recommendation information is transmitted to the first client terminal, certification for the first member is conducted, and then a first required number which is the number of required tickets for participating in the tournament of the second game by referring to the ticket number information storage unit, and confirming the quantity of holding tickets held by the first member by referring to the ticket quantity information storage unit; and allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number.

According to exemplary embodiments of the present disclosure, there are provided a service providing server for providing a game service that supports participation in a tournament for a game using a ticket, and recommends a customized game to a user, and the operating method thereof to support members to enjoy a game while competing with other members in a tournament scheme in an online environment, and at the same time, support a member who subscribes in the game service to be recommended with an optimal game according to a preferred genre thereof.

### BRIEF DESCRIPTION OF THE DRAWINGS

FIG. 1 is a diagram illustrating a structure of a service providing server for providing a game service that supports participation in a tournament for a game using a ticket, and recommends a customized game to a user according to an exemplary embodiment of the present disclosure.

FIG. 2 is a diagram describing an operation of a service providing server for providing a game service that supports participation in a tournament for a game using a ticket, and recommends a customized game to a user according to an exemplary embodiment of the present disclosure.

FIG. 3 is a flowchart illustrating an operating method of a service providing server for providing a game service that supports participation in a tournament for a game using a ticket, and recommends a customized game to a user according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

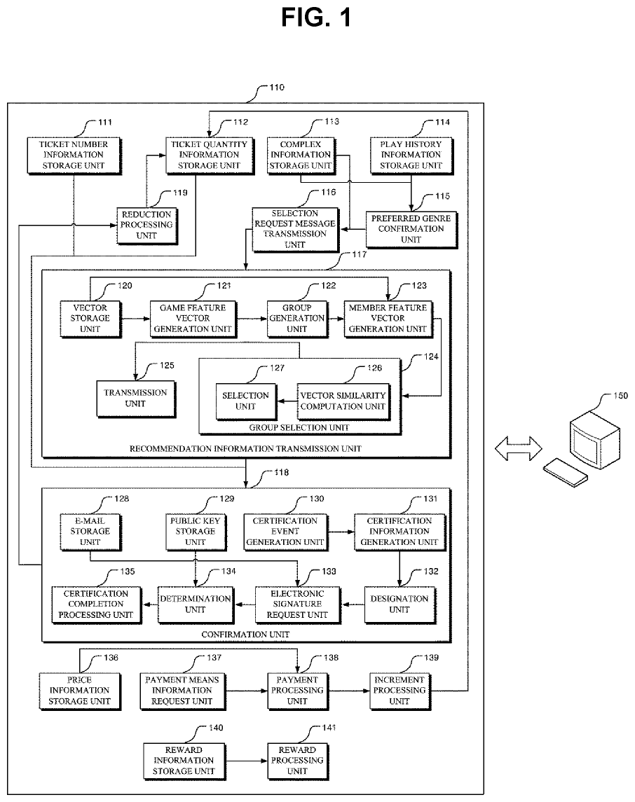

FIG. 1 is a diagram illustrating a structure of a service providing server for providing a game service that supports participation in a tournament for a game using a ticket, and recommends a customized game to a user according to an exemplary embodiment of the present disclosure.

Referring to FIG. 1, the service providing server 110 according to the present disclosure includes a ticket number information storage unit 111, a ticket quantity information storage unit 112, a complex information storage unit 113, a play history information storage unit 114, a preferred genre confirmation unit 115, a selection request message transmission unit 116, a recommendation information transmission unit 117, a confirmation unit 118, and a reduction processing unit 119.

The ticket number information storage unit 111 stores information on the number of required tickets for participating in tournaments of a plurality of predetermined respective games.

For example, the ticket number information storage unit 111 may store information shown in Table 1 below.

TABLE 1

| Plurality | Number of |
|---|---|
| of games | required tickets |
| Game 1 | 2 |
| Game 2 | 1 |
| Game 3 | 5 |
| Game 4 | 7 |
| . . . | . . . |
| Game 10 | 4 |

The ticket quantity information storage unit 112 stores information on the quantity of holding tickets held by each of a plurality of members which subscribes to the game service.

For example, the ticket quantity information storage unit 112 may store information shown in Table 2 below.

TABLE 2

| Plurality | Quantity of |
|---|---|
| of members | holding tickets |
| Member 1 | 0 |
| Member 2 | 30 |
| Member 3 | 10 |
| Member 4 | 5 |
| . . . | . . . |
| Member 10 | 15 |

The complex information storage unit 113 stores member identification information for each of the plurality of members, and information on a predetermined preferred genre corresponding to each of the plurality of members (the preferred genre of each of the plurality of members means any one genre pre-selected to be a genre preferred by each member among predetermined s (s is a natural number of 3 or more) types of genres.

Here, the member identification information means unique information for identifying each member such as an ID, a resident registration number, etc., pre-issued for each member.

For example, when it is assumed that s is ‘5’, and predetermined five types of genres are ‘RPG, adventure, shooting, racing, and sports’, the complex information storage unit 113 may store information shown in Table 3 below.

TABLE 3

| Member identification | | |
|---|---|---|
| information for plurality | | Preferred |
| of respective members | | genre |
| Member 1 | Member identification | RPG |
| | information 1 | |
| Member 2 | Member identification | Sports |
| | information 2 | |
| Member 3 | Member identification | Racing |
| | information 3 | |
| Member 4 | Member identification | Adventure |
| | information 4 | |
| Member 5 | Member identification | Shooting |
| | information 5 | |
| Member 6 | Member identification | Adventure |
| | information 6 | |
| Member 7 | Member identification | Racing |
| | information 7 | |
| Member 8 | Member identification | Sports |
| | information 8 | |
| Member 9 | Member identification | RPG |
| | information 9 | |
| Member 10 | Member identification | Shooting |
| | information 10 | |

The play history information storage unit 114 stores play history information

corresponding to each of the plurality of games (the play history information of each of the plurality of games means information configured by members identification information for each of members who plays each game once or more).

For example, the play history information storage unit 114 may store information shown in Table 4 below.

TABLE 4

| Plurality of games | Play history information |
|---|---|
| Game 1 | Play history information 1 |
| | (Member identification information 1 and |
| | Member identification information 9) |
| Game 2 | Play history information 2 |
| | (Member identification information 5 and |
| | Member identification information 10) |
| Game 3 | Play history information 3 |
| | (Member identification information 1) |
| Game 4 | Play history information 4 |
| | (Member identification information 10) |
| Game 5 | Play history information 5 |
| | (Member identification information 2 and |
| | Member identification information 8) |
| Game 6 | Play history information 6 |
| | (Member identification information 3 and |
| | Member identification information 7) |
| Game 7 | Play history information 7 |
| | (Member identification information 7) |
| Game 8 | Play history information 8 |
| | (Member identification information 2, |
| | Member identification information 3, |
| | and Member identification information 7) |
| Game 9 | Play history information 9 |
| | (Member identification information 4) |
| Game 10 | Play history information 10 |
| | (Member identification information 4, |
| | Member identification information 6, |
| | and Member identification information 9) |

In such a situation, when a recommendation request instruction of a customized game is received from a first client terminal 150 held by a first member which is any one of the plurality of members, the preferred genre confirmation unit 115 confirms member identification information for each of members who plays each game once or more from the play history information corresponding to each of the plurality of games stored in the play history information storage unit 114, and then confirms a preferred genre for each of the members who play each game once or more with respect to each of the plurality of games by referring to the complex information storage unit 113.

The selection request message transmission unit 116 confirms a first preferred genre for the first member by referring to the complex information storage unit 113, and generates and transmits a selection request message for requesting the first client terminal 150 to select t (t is a natural number of 2 or more or less than s) additional preferred genres for recommending the customized game among the s types of genres to the first client terminal 150.

For example, it is assumed that t is ‘2’, and the recommendation request instruction of the customized game is received from the first client terminal 150 to the service providing server 110 held by ‘member 3’ which is the first member which is any one of ‘member 1, member 2, member 3, member 4, . . . , member 10’ which are the plurality of members.

Then, the preferred genre confirmation unit 115 may confirm the member identification information for each of the members who plays each game once more from ‘play history information 1, play history information 2, play history information 3, play history information 4, . . . , play history information 10’ which are the play history information corresponding to ‘game 1, game 2, game 3, game 4, . . . , game 10’ which are the plurality of games stored in the play history information storage unit 114 shown in Table 4 above, respectively.

Thereafter, the preferred genre confirmation unit 115 may confirm the preferred genre for each of the members who play each game once more with respect to ‘game 1, game 2, game 3, game 4, . . . , game 10’ which are the plurality of games as shown in Table 5 below, by referring to the complex information storage unit 113 shown in Table 3 above.

TABLE 5

| Plurality of | Preferred genre for respective members |
|---|---|
| games | who play each game once or more |
| Game 1 | Preferred genre for member 1: RPG |
| | Preferred genre for member 9: RPG |
| Game 2 | Preferred genre for member 5: Shooting |
| | Preferred genre for member 10: Shooting |
| Game 3 | Preferred genre for member 1: RPG |
| Game 4 | Preferred genre for member 10: Shooting |
| Game 5 | Preferred genre for member 2: Sports |
| | Preferred genre for member 8: Sports |
| Game 6 | Preferred genre for member 3: Racing |
| | Preferred genre for member 7: Racing |
| Game 7 | Preferred genre for member 7: Racing |
| Game 8 | Preferred genre for member 2: Sports |
| | Preferred genre for member 3: Racing |
| | Preferred genre for member 7: Racing |
| Game 9 | Preferred genre for member 4: Adventure |
| Game 10 | Preferred genre for member 4: Adventure |
| | Preferred genre for member 6: Adventure |
| | Preferred genre for member 9: RPG |

Then, the selection request message transmission unit 116 may confirm ‘racing’ which is the first preferred genre for ‘member 3’ which is the first member by referring to the complex information storage unit 113 shown in Table 3 above, and generate and transmit a selection request message for requesting the first client terminal 150 to select two additional preferred genres for recommending a customized game among ‘RPG, adventure, shooting, racing, and sports’ which are the five types of genres to the first client terminal 150.

When information on t first additional preferred genres among the s types of genres are from the first client terminal 150 in response to the selection request message, the recommendation information transmission unit 117 selects at least one first game matched with the first preferred genre and the t first additionally preferred genres among the plurality of games based on the preferred genre for each of the members who play each game once or more, which is confirmed with respect to each of the plurality of games, and then transmits, to the first client terminal 150, recommendation information indicating that the at least one first game is a recommendation game for the first member.

In this case, according to an exemplary embodiment of the present disclosure, the recommendation information transmission unit 117 may include a vector storage unit 120, a game feature vector generation unit 121, a group generation unit 122, a member feature vector generation unit 123, a group selection unit 124, and a transmission unit 125.

The vector storage unit 120 stores different one-hot vectors predetermined for the s types of respective genres.

For example, as in the above-described example, when it is assumed that s is ‘5’, and predetermined five types of genres are ‘RPG, adventure, shooting, racing, and sports’, the vector storage unit 120 may store information shown in Table 6 below.

TABLE 6

| 5 types of genres | One-hot vector |
|---|---|
| RPG | [1 0 0 0 0] |
| Adventure | [0 1 0 0 0] |
| Shooting | [0 0 1 0 0] |
| Racing | [0 0 0 1 0] |
| Sports | [0 0 0 0 1] |

When the t first additional preferred genres are received from the first client terminal 150, the game feature vector generation unit 121 confirms the one-hot vector of the preferred genre for each of the members who play each game once or more with respect to each of the plurality of games by referring to the vector storage unit 120, generates the aggregation vector by aggregating all one-hot vectors of the preferred genres for the respective members who play each game once or more, and then generates a game feature vector corresponding to each of the plurality of games by dividing the aggregation vector by the number of members who play each game once or more.

When the game feature vector corresponding to each of the plurality of games is generated, the group generation unit 122 generates k groups by performing k (k is a natural number of 3 or more)—mean clustering with respect to the plurality of games based on the game feature vector corresponding to each of the plurality of games.

Here, the k-mean clustering which means an algorithm that binds data configured in the form of a vector into k groups is an algorithm that clusters data into k groups based on a distance between a center of a group to which data belongs and each data.

When the k groups are generated, the member feature vector generation unit 123 confirms the one-hot vector for the first preferred genres and the one-hot vector for each of the t first additional preferred genres by referring to the vector storage unit 120, and then applies a predetermined first weight (the first weight is a rational number of more than 0 and less than 1) to the one-hot vector for the first preferred genres, applies a predetermined second weight (the second weight which is a smaller value than the first weight is a rational number of more than 0 and less than 1) to the one-hot vector for each of the t first additional preferred genres, and then aggregates both one-hot vectors for the first preferred genre and one hot-vectors for the t respective first additionally preferred genres to generate a member feature vector.

When the member feature vector is generated, the group selection unit 124 selects a first group having a maximum similarity to the member feature vector among the k groups.

In this case, according to an exemplary embodiment of the present disclosure, the group selection unit 124 may include a vector similarity computation unit 126 and a selection unit 127.

The vector similarity computation unit 126 computes a vector similarity between the member feature vector and a centroid vector corresponding to a centroid of each of the k groups when the member feature vector is generated.

Here, a cosine similarity or Euclidean distance may be utilized as the vector similarity.

The selection unit 127 selects, as the first group, a group having a centroid vector having a maximum vector similarity to the member feature vector among the k groups.

When the first group is selected, the transmission unit 125 selects games belonging to the first group as at least one first game, and then transmits the recommendation information indicating that the at least one first game is a recommendation game for the first member, with respect to the first client terminal 150.

Hereinafter, the operations of the game feature vector generation unit 121, the group generation unit 122, the member feature vector generation unit 123, the vector similarity computation unit 126, the selection unit 127, and the transmission unit 125 will be described in detail as an example.

First, as in the above-described example, it is assumed that t is ‘2’, and the two first additional preferred genres such as ‘shooting and sports’ are received from the first client terminal 150 of ‘member 3’ in response to the selection request message.

Then, the game feature vector generation unit 121 may confirm the one-hot vector of the preferred genre for each of the members who play each game once or more with respect to each of ‘game 1, game 2, game 3, game 4, . . . , game 10’ which are the plurality of games by referring to the vector storage unit 120 shown in Table 6 above, generate the aggregation vector by aggregating all one-hot vectors of the preferred genres for the respective members who play each game once or more, and then generate a game feature vector corresponding to each of ‘game 1, game 2, game 3, game 4, . . . , game 10’ which are the plurality of games by dividing the aggregation vector by the number of members who play each game once or more.

In this regard, contents in which the game feature vector generation unit 121 generates the game feature vector with respect to ‘game 1’ are described in detail as below. First, by referring to the vector storage units 120 shown in Tables 5 and 6 above at the same time, since preferred genres for ‘member 1 and member 9’ which are the members who play ‘game 1’ once or more are ‘RPG and RPG’, respectively, and the one-hot vector for ‘RPG’ is ‘[1 0 0 0 0]’, the game feature vector generation unit 121 aggregates all of ‘[1 0 0 0 0] and [1 0 0 0 0]’ which are the one-hot vectors of ‘RPG and RPG’ which are the preferred genres for ‘member 1 and member 9’ to generate an aggregation vector such as ‘[2 0 0 0 0]’, and then divides ‘[2 0 0 0 0]’ which is the aggregation vector by ‘2’ which is the number of ‘member 1 and member 9’ to generate the game feature vector corresponding to ‘game 1’ as ‘[1 0 0 0 0]’. By such a scheme, the game feature vector generation unit 121 may generate the game feature vector with respect to ‘game 1, game 2, game 3, game 4, . . . , game 10’ as shown in Table 7 below.

TABLE 7

| Plurality of games | Game feature vector |
|---|---|
| Game 1 | [1 0 0 0 0] |
| Game 2 | [0 0 1 0 0] |
| Game 3 | [1 0 0 0 0] |
| Game 4 | [0 0 1 0 0] |
| Game 5 | [0 0 0 0 1] |
| Game 6 | [0 0 0 1 0] |
| Game 7 | [0 0 0 1 0] |
| Game 8 | [0 0 0 0.66 0.33] |
| Game 9 | [0 1 0 0 0] |
| Game 10 | [0.33 0.66 0 0 0] |

As such, when game feature vectors corresponding to ‘game 1, game 2, game 3, game 4, . . . , game 10’ which are the plurality of games, respectively are generated by the game feature vector generation unit 121 as shown in Table 7 above, the group generation unit 122 may generate k groups by performing k-mean clustering with respect to ‘game 1, game 2, game 3, game 4, . . . , game 10’ which are the plurality of games based on ‘[1 0 0 0 0], [0 0 1 0 0], [1 0 0 0 0], [0 0 1 0 0], [0 0 0 0 1], [0 0 0 1 0], [0 0 0 1 0], [0 0 0 0.66 0.33], [0 1 0 0 0], [0.33 0.66 0 0 0]’ which are the game feature vectors corresponding to ‘game 1, game 2, game 3, game 4, . . . , game 10’ which are the plurality of games, respectively.

When it is assumed that k is ‘3’, and three groups are generated as in ‘group 1 (game 1 and game 3), group 2 (game 2, game 4, game 5, game 6, game 7, and game 8), and group 3 (game 9 and game 10)’ by the group generation unit 122, the member feature vector generation unit 123 may confirm ‘[0 0 0 1 0]’ which is the one-hot vector for ‘racing’ which is the first preferred genre of ‘member 3’, and ‘[0 0 1 0 0] and [0 0 0 0 1]’ which are the one-hot vectors for ‘shooting and sports’ which are the two first additional preferred genres of ‘member 3’, respectively by referring to the vector storage unit 120 shown in Table 6 above.

Thereafter, the member feature vector generation unit 123 may apply a predetermined first weight to the one-hot vector for ‘racing’ which is the first preferred genre, and apply a predetermined second weight to the one-hot vector for each of ‘shooting and sports’ which are the two first additional preferred genres.

Here, when it is assumed that the predetermined first weight is ‘0.5’ and the predetermined second weight is ‘0.25’, the member feature vector generation unit 123 may apply ‘0.5’ which is the first weight to ‘[0 0 0 1 0]’ which is the one-hot vector for ‘racing’ which is the first preferred genre, and apply ‘0.25’ which is the second weight to ‘[0 0 1 0 0] and [0 0 0 0 1]’ which are the one-hot vectors for ‘shooting and sports’ which are the two first additional preferred genres, respectively.

Then, the member feature vector generation unit 123 aggregates both ‘[0 0 0 0.5 0]’ which is one-hot vector for ‘racing’ which is the first preferred genre to which ‘0.5’ which is the first weight is applied, and ‘[0 0 0.25 0 0] and [0 0 0 0 0.25]’ which are the one-hot vectors for ‘shooting and sports’ which are the two first additional preferred genres to which ‘0.25’ which is the second weight is applied, respectively to generate member feature vectors such as ‘[0 0 0.25 0.5 0.25]’.

As such, when the member feature vector is generated by the member feature vector generation unit 123, the vector similarity computation unit 126 may compute, as ‘S₁, S₂, and S₃’, vector similarities between ‘[0 0 0.25 0.5 0.25]’ which are the member feature vectors, and ‘V_{1C}, V_{2C}, and V_{3C}’ which are centroid vectors corresponding to centroids of ‘group 1, group 2, and group 3’ which are the three groups, respectively.

When it is assumed that the maximum vector similarity among ‘S₁, S₂, and S₃’ is ‘S₂’, the vector similarity computation unit 126 may select, as the first group, ‘group 2’ having a centroid vector from which ‘S₂’ is derived among ‘group 1, group 2, and group 3’.

As such, when the first group is selected by the selection unit 127, the transmission unit 125 may select, the at least one first game, ‘game 2, game 4, game 5, game 6, game 7, and game 8’ which are games belonging to ‘group 2’ which is the first group, and then transmit the recommendation information indicating that ‘game 2, game 4, game 5, game 6, game 7, and game 8’ which are the at least one first game are recommendation games for ‘member 3’ which is the first member, with respect to the first client terminal 150.

According to an exemplary embodiment of the present disclosure, an operator of the service providing server 110 may hold a tournament competition for each of the plurality of games in order to allow the members to enjoy the game jointly, and in this case, the operator may open a tournament session of each of the plurality of games online in order to allow the members to participate in the tournament competition for each of the plurality of games online through client terminals held by the members.

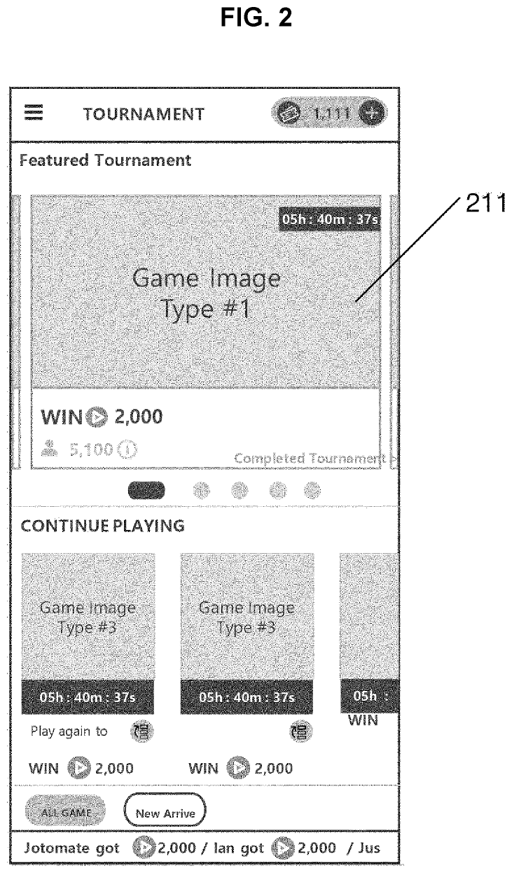

In this regard, FIG. 2 is a diagram illustrating an example of a screen in which when a specific member accesses the service providing server 110 through a client terminal thereof, a tournament session of each of the plurality of games is opened, which may be viewed through the client terminal. Here, when reference numeral 211 of FIG. 2 represents a screen in which a tournament session for any one game of the plurality of games is opened, the tournament session means a session opened so as for members who access the tournament session to play the game online jointly through the client terminal. That is, multiple members access the tournament session through client terminals thereof to play the game jointly with each other online.

As a result, when the first member accesses the service providing server 110 through a first client terminal 150 thereof, the first member may view a waiting room screen having a UI shown in FIG. 2 through the first client terminal 150.

In this case, when the first member is recommended with the at least one first game from the service providing server 110 according to the present disclosure according to the above-described scheme, and then clicks on a tournament session for a second game represented by reference numeral 211 among the one or more first games through the first client terminal 150, the first client terminal 150 may transmit an access request command to the tournament session, to the service providing server 110 of the present disclosure.

In this case, when the confirmation unit 118 receives, from the first client terminal 150, the access request command to the tournament session opened for the second game, the confirmation unit 118 conducts certification for the first member, and then confirms a first required number which is the number of required tickets for participating in the tournament of the second game by referring to the ticket number information storage unit 111, and confirms the quantity of holding tickets held by the first member by referring to the ticket quantity information storage unit 112.

When it is confirmed that the quantity of holding tickets held by the first member is equal to or more than the first required number, the reduction processing unit 119 allows the first client terminal 150 to access the tournament session, and then reduces the quantity of holding tickets held by the first member stored in the ticket quantity information storage unit 112 by the first required number.

Hereinafter, the operations of the confirmation unit 118 and the reduction processing unit 119 will be described in detail as an example.

First, it is assumed that the second game is ‘game 2’ and the first member is ‘member 3’.

In this case, when the service providing server 110 receives, from the first client terminal 150, the access request command to the tournament session opened for ‘game 2’ which is the second game, the confirmation unit 118 may conduct certification for ‘member 3’ which is the first member, and then confirm, as a first required number, ‘1’ which is the number of required tickets for participating in the tournament of ‘game 2 which is the second game by referring to the ticket number information storage unit 111 shown in Table 1 above, and confirm ‘10’ as the quantity of holding tickets held by ‘member 3’ which is the first member by referring to the ticket quantity information storage unit 112 shown in Table 2 above.

In this case, since ‘10’ which is the quantity of holding tickets held by ‘member 3’ which is the first member is equal to or more than ‘1’ which is the first required number, the reduction processing unit 119 reduces ‘10’ which is the quantity of holding tickets held by ‘member 3’ which is the first member stored in the ticket quantity information storage unit 112 shown in Table 2 above by ‘1’ which is the first required number after allowing the access of the first client terminal 150 to the tournament session to update quantity information for ‘member 3’ as in Table 8 below.

TABLE 8

| | Quantity of |
|---|---|
| Plurality of members | holding tickets |
| Member 1 | 0 |
| Member 2 | 30 |
| Member 3 | 9 |
| Member 4 | 5 |
| . . . | . . . |
| Member 10 | 15 |

According to an exemplary embodiment of the present disclosure, the service providing server 110 may further include a component which conducts a process of upon receiving the access request command to the tournament session opened for the second game from the first client terminal 150 of the first member, conducting the certification for the first member, and then only when it is confirmed that the first member is a certified member, determining whether to allow the first client terminal 150 to access the tournament session based on the ticket held by the first member.

To this end, the confirmation unit 118 may include an e-mail storage unit 128, a public key storage unit 129, a certification event generation unit 130, a certification information generation unit 131, a designation unit 132, an electronic signature request unit 133, a determination unit 134, and a certification completion processing unit 135.

The e-mail storage unit 128 stores information on a predetermined e-mail address

for each of the plurality of members.

For example, information as shown in Table 9 below may be stored in the e-mail storage unit 128.

TABLE 9

| Plurality of members | E-mail address |
|---|---|
| Member 1 | E-mail address 1 |
| Member 2 | E-mail address 2 |
| Member 3 | E-mail address 3 |
| Member 4 | E-mail address 4 |
| . . . | . . . |
| Member 10 | E-mail address 10 |

The public key storage unit 129 stores a public key corresponding to a private key (the private key for each of the plurality of members is prestored in the client terminal of each member) pre-issued for each of the plurality of members.

For example, the public key storage unit 129 may store a public key corresponding to a private key pre-issued for each of the plurality of members as in Table 10 below.

TABLE 10

| Private key pre-issued for each | | |
|---|---|---|
| of plurality of members | | Public key |
| Member 1 | Private key 1 | Public key 1 |
| Member 2 | Private key 2 | Public key 2 |
| Member 3 | Private key 3 | Public key 3 |
| Member 4 | Private key 4 | Public key 4 |
| . . . | . . . | . . . |
| Member 10 | Private key 10 | Public key 10 |

The certification event generation unit 130 generates a certification event for conducting the certification for the first member when receiving the access request command to the tournament session from the first client terminal 150.

The certification information generation unit 131 randomly generates, when the certification event is generated, an n (n is a natural number of 2 or more)-digit first certification number, randomly generates a certification value constituted by a natural number having a size of 9 or less, and then, performs a modulo operation having the certification value as a divisor for respective digit numbers constituting the first certification number to generate an n-digit second certification number.

The designation unit 132 generates a column vector having respective digit numbers constituting the first certification number as components and a row vector having respective digit numbers constituting the second certification number as components, and computes a matrix multiplication between the column vector and the row vector to generate an operation matrix of an n×n size, and then computes Frobenius Norm of the operation matrix, and designates the Frobenius Norm of the operation matrix as a verification value for member certification.

Here, when there is matrix A having a size of p×q, the Frobenius Norm of the matrix A may be computed according to Equation 1 below.

$${‖ A ‖}_{F} = \sqrt{{\sum }_{i = 1}^{p} {\sum }_{j = 1}^{q} {a}_{i j}^{2}} \qquad [ Equation 1 ]$$

In Equation 1 above, ∥A∥_{F} means the Frobenius Norm of the matrix A and aᵢⱼ means a component at a location of i-th row and j-th column among components of the matrix A.

The electronic signature request unit 133 confirms a first e-mail address for the first member by referring to the e-mail storage unit 128, sends a certification e-mail including the first certification number with the first e-mail address as a receiving side, and then transmits the certification value to the first client terminal 150, and at the same time, requests an electronic signature based on the first certification number and the certification value.

In this case, according to an exemplary embodiment of the present disclosure, the first client terminal 150 may pre-store a first private key pre-issued for the first member in the first client terminal 150, and upon receiving the electronic signature request from the service providing server 110 jointly with the certification value, the first client terminal 150 may display a message for requesting the first member to input the first certification number included in the certification e-mail received by an account according to the first e-mail address into the first client terminal 150.

In this case, when the first member inputs, into the first client terminal 150, the first certification number included in the certification e-mail received by the account according to the first e-mail address in response to the message, the first client terminal 150 performs the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computes the matrix multiplication between the column vector and the row vector to generate the operation matrix of the n×n size, and then encrypts the Frobenius Norm of the operation matrix with the first private key stored in the first client terminal 150 to generate a first electronic signature value, and transmit the first electronic signature value to the service providing server 110.

When the determination unit 134 receives the first electronic signature value from the first client terminal 150 in response to the electronic signature request, the determination unit 134 decrypts the first electronic signature value with the first public key corresponding to the first private key stored in the public key storage unit 129 to generate a decryption value, and then determines whether the decryption value is equal to the Frobenius Norm of the operation matrix designated as the verification value.

The certification completion processing unit 135 completes certification for the first member when it is determined that the decryption value is equal to the Frobenius Norm of the operation matrix designated as the verification value.

Hereinafter, the operations of the certification event generation unit 130, the certification information generation unit 131, the designation unit 132, the electronic signature request unit 133, the first client terminal 150, the determination unit 134, and the certification completion processing unit 135 will be described in detail as an example.

First, it is assumed that ‘n=3’, and as in the above-described example, the service providing server 110 receives the access request command to the tournament session from the first client terminal 150.

Then, the certification event generation unit 130 may generate a certification event for conducting the certification for ‘member 3’ which is the first member.

As described above, when the certification event is generated by the certification event generation unit 130, the certification information generation unit 131 may randomly generate a 3-digit first certification number as ‘642’, and randomly generate a certification value configured by a natural number having a size of 9 or less as ‘5’.

Thereafter, the certification information generation unit 131 performs a modulo operation having ‘5’ which is the certification value as the divisor for respective-digit numbers constituting ‘642’ which is the first certification number to generate a 3-digit second certification number, ‘142’.

Then, the designation unit 132 may generate

$$[ \begin{matrix}6 \\ 4 \\ 2\end{matrix} ]$$

which is a 3D column vector having the respective-digit numbers constituting ‘642’ which is the first certification number as components, and ‘[1 4 2]’ which is a 3D row vector having respective-digit numbers constituting ‘142’ which is the second certification number as components.

Thereafter, the designation unit 132 computes a matrix multiplication between

$$[ \begin{matrix}6 \\ 4 \\ 2\end{matrix} ]$$

which is the column vector and ‘[1 4 2]’ which is the row vector to generate an operation matrix having a size of 3×3 such as

$$[ \begin{matrix}6 & 24 & 12 \\ 4 & 16 & 8 \\ 2 & 8 & 4\end{matrix} ] .$$

As described above, when the operation matrix is generated by the designation unit 132, the designation unit 132 may compute the Frobenius Norm of

$$[ \begin{matrix}6 & 24 & 12 \\ 4 & 16 & 8 \\ 2 & 8 & 4\end{matrix} ]$$

which is the operation matrix as ‘34.29’ according to Equation 1 above, and designate ‘34.29’ which is the Frobenius Norm as a verification value for member certification.

Then, the electronic signature request unit 133 may confirm ‘e-mail address 3’ which is the first e-mail address for ‘member 3’ which is the first member by referring to the e-mail storage unit 128 shown in Table 9 above, send a certification e-mail including ‘642’ which is the first certification number with ‘e-mail address 3’ which is the first e-mail address as a receiving side, and then transmit ‘5’ which is the certification value to the first client terminal 150, and at the same time, request an electronic signature based on ‘642’ which is the first certification number and ‘5’ which is the certification value.

In this case, the first client terminal 150 may pre-store ‘private key 3’ which is the first private key pre-issued for ‘member 3’ which is the first member in the first client terminal 150, and when the first client terminal 150 receives the electronic signature request from the service providing server 110 jointly with ‘5’ which is the certification value, the first client terminal 150 may display a message which requests ‘member 3’ which is the first member to input the first certification number included in the certification e-mail received into the account according to ‘e-mail address 3’ which is the first e-mail address into the first client terminal 150.

Then, ‘member 1’ which is the first member logs into the account according to ‘e-mail address 3’ which is the first e-mail address to confirm the certification e-mail, and confirms ‘642’ which is the first certification number included in the certification e-mail to input ‘642’ into the first client terminal 150.

As such, when ‘member 3’ which is the first member inputs ‘642’ which is the first certification number included in the certification e-mail into the first client terminal 150, the first client terminal 150 performs a modulo operation having ‘5’ which is the certification value as the divisor for respective digit numbers constituting ‘642’ which is the first certification number to generate a 3-digit second certification number as ‘142’.

Then, the first client terminal 150 may generate

$$[ \begin{matrix}6 \\ 4 \\ 2\end{matrix} ]$$

which is the column vector having the respective-digit numbers constituting ‘642’ which is the first certification number as components, and ‘[1 4 2]’ which is the row vector having respective-digit numbers constituting ‘142’ which is the second certification number as components.

Thereafter, the first client terminal 150 computes a matrix multiplication between

$$[ \begin{matrix}6 \\ 4 \\ 2\end{matrix} ]$$

which is the column vector and ‘[1 4 2]’ which is the row vector to generate an operation matrix having a size of 3×3 such as

$$[ \begin{matrix}6 & 24 & 12 \\ 4 & 16 & 8 \\ 2 & 8 & 4\end{matrix} ] .$$

Then, the first client terminal 150 may compute the Frobenius Norm of

$$[ \begin{matrix}6 & 24 & 12 \\ 4 & 16 & 8 \\ 2 & 8 & 4\end{matrix} ]$$

which is the operation matrix as ‘34.29’ according to Equation 1 above, and encrypt ‘34.29’ which is the Frobenius Norm with ‘private key 3’ which is the first private key stored in the first client terminal 150 to generate a first electronic signature value, and then transmit the first electronic signature value to the service providing server 110.

In this case, when the service providing server 110 receives the first electronic signature from the first client terminal 150, the determination unit 134 decrypts the first electronic signature value with ‘public key 3’ which is the first public key corresponding to ‘private key 3’ which is the first private key stored in the public key storage unit 129 shown in

Table 10 above to generate a decryption value such as ‘34.29’, and then determine whether ‘34.29’ which is the decryption value is equal to ‘34.29’ which is the Frobenius Norm designated as the verification value.

In this case, since ‘34.29’ which is the decryption value is equal to ‘34.29’ which is the Frobenius Norm designated as the verification value, the certification completion processing unit 135 may complete the certification for ‘member 3’ which is the first member.

According to an exemplary embodiment of the present disclosure, the service providing server 110 may further include a price information storage unit 136, a payment means information request unit 137, a payment processing unit 138, and an increment processing unit 139.

The price information storage unit 136 stores purchase price information of the ticket for participating in the tournament.

For example, the price information storage unit 136 may store purchase price information of ‘5000 won per ticket’ as the purchase price information of the ticket.

When the payment means information request unit 137 receives a purchase request command for requesting purchasing tickets corresponding to a first purchase quantity from the first client terminal 150, the payment means information request unit 137 requests transmitting payment means information for cost payment.

When the payment processing unit 138 receives first payment means information from the first client terminal 150, the payment processing unit 138 calculates a price corresponding to the first purchase quantity based on the purchase price information, and then performs cost payment processing for the calculated price based on the first payment means information.

When the cost payment processing is completed, the increment processing unit

139 increases the quantity of holding tickets held by the first member stored in the ticket quantity information storage unit 112 by the first purchase quantity.

Hereinafter, the operations of the payment means information request unit 137, the payment processing unit 138, and the increment processing unit 139 will be described in detail as an example.

First, as in the above-described example, it is assumed that after ‘10 which is the quantity of holding tickets held by ‘member 3’ which is the first member is reduced by ‘1’ which is the first required number by the reduction processing unit 119, and then the service providing server 110 receives the purchase request command for requesting purchasing tickets corresponding to the first purchase quantity such as ‘5’ from the first client terminal 150.

Then, the payment means information request unit 137 may request transmitting the payment means information for cost payment.

In response thereto, when the service providing server 110 receives ‘credit card information’ from the first client terminal 150, the payment processing unit 138 may calculate, as 25000 won', a price corresponding to ‘5’ which is the first purchase quantity based on the purchase price information.

Thereafter, the payment processing unit 138 may perform cost payment processing for ‘25000 won’ which is the calculated price based on the ‘credit card information’.

As such, when the cost payment processing is completed by the payment processing unit 138, the increment processing unit 139 increases ‘9 which is the quantity of holding tickets held by ‘member 3’ which is the first member stored in the ticket quantity information storage unit 112 shown in Table 8 above by ‘5’ which is the first purchase quantity to update quantity information for ‘member 3’ as in Table 11 below.

TABLE 11

| Plurality of | Quantity of |
|---|---|
| members | holding tickets |
| Member 1 | 0 |
| Member 2 | 30 |
| Member 3 | 14 |
| Member 4 | 5 |
| . . . | . . . |
| Member 10 | 15 |

According to an exemplary embodiment of the present disclosure, the service providing server 110 may further include a reward information storage unit 140 and a reward processing unit 141.

The reward information storage unit 140 stores information on the amount of payment of cryptocurrency to be paid as a reward when winning the tournament for each of the plurality of games.

For example, the reward information storage unit 140 may store information as in Table 12 below.

TABLE 12

| Plurality | Payment amount |
|---|---|
| of games | of cryptocurrency |
| Game 1 | 5 coins |
| Game 2 | 2 coins |
| Game 3 | 13 coins |
| Game 4 | 20 coins |
| . . . | . . . |
| Game 10 | 7 coins |

When an event is generated, which indicates that the first member is a winner through the tournament session as the first member wins the tournament for the second game after the first member completes participating in the tournament for the second game as the first client terminal 150 accesses the tournament session, the reward processing unit 141 confirms a first payment amount which is the payment amount of the cryptocurrency to be paid as the reward when winning the tournament for the second game by referring to the reward information storage unit 140, and receives information on a wallet address of the first member for accumulating the cryptocurrency from the first client terminal 150, and then transfers the cryptocurrency of the first payment amount to the wallet address of the first member to complete the reward processing for the first member.

In this regard, as in the above-described example, a situation is assumed in which the second game is ‘game 2’, and as the first client terminal 150 accesses the tournament session opened for ‘game 2’, the first member completes participating in the tournament for the ‘game 2’.

When the first member wins the tournament for ‘game 2’, the service providing server 110 of the present disclosure may generate an event indicating that the first member is the winner through the tournament session opened for ‘game 2’. As such, when the event indicating that the first member is the winner is generated through the tournament session for ‘game 2’, the reward processing unit 141 may confirm that the payment amount of the cryptocurrency to be paid as the reward when winning the tournament for ‘game 2’ is ‘2 coins’ by referring to the reward information storage unit 140.

Then, the reward processing unit 141 requests the first client terminal 150 to transmit the information on the wallet address of the first member for accumulating the cryptocurrency, and then when receiving the information on the wallet address of the first member from the first client terminal 150, transfers the cryptocurrency of ‘2 coins’ to the wallet address of the first member to complete the reward processing for the first member.

Through this, when the members who subscribes to and registers in the game service of the present disclosure win the tournaments for the games participated thereby, the members may receive the rewards thereof as the cryptocurrency, and will be able to more actively participate in the tournaments for the games due to the reward.

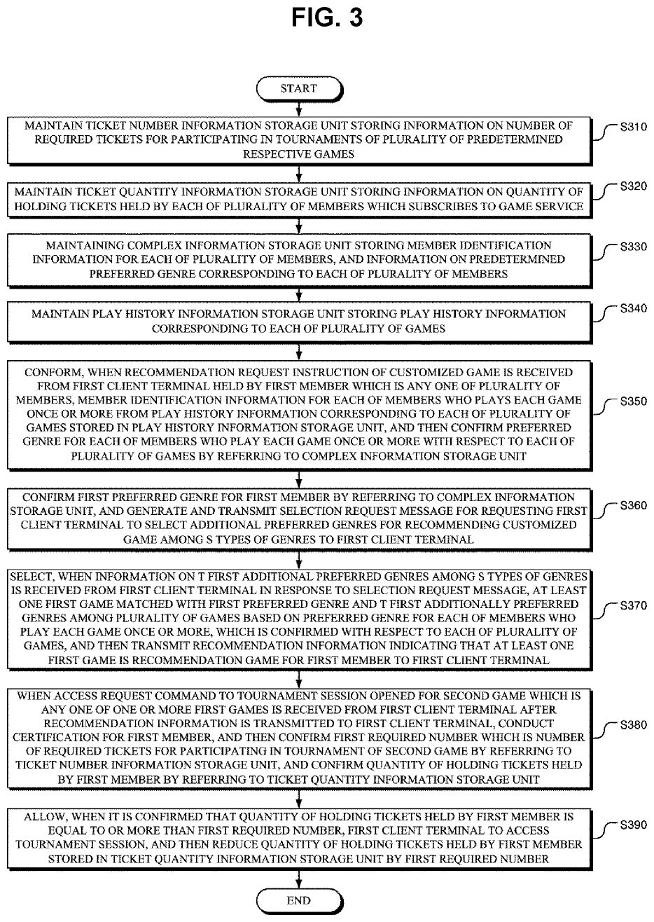

FIG. 3 is a flowchart illustrating an operating method of a service providing server for providing the game service that supports participation in a tournament for a game using a ticket and that gives the customized score according to the record about the member who participated in the tournament according to an exemplary embodiment of the present disclosure.

In step S310, a ticket number information storage unit is maintained, which stores information on the number of required tickets for participating in tournaments of a plurality of predetermined respective games.

In step S320, a ticket quantity information storage unit is maintained, which stores information on the quantity of holding tickets held by each of a plurality of members which subscribes to the game service.

In step S330, a complex information storage unit is maintained, which stores member identification information for each of the plurality of members, and information on a predetermined preferred genre corresponding to each of the plurality of members (the preferred genre of each of the plurality of members means any one genre pre-selected to be a genre preferred by each member among predetermined s (s is a natural number of 3 or more) types of genres.

In step S340, a play history information storage unit is maintained, which stores play history information corresponding to each of the plurality of games (the play history information of each of the plurality of games means information configured by members identification information for each of members who plays each game once or more).

In step S350, when a recommendation request instruction of a customized game is received from a first client terminal held by a first member which is any one of the plurality of members, member identification information for each of members who plays each game once or more is confirmed from the play history information corresponding to each of the plurality of games stored in the play history information storage unit, and then a preferred genre for each of the members who play each game once or more is confirmed with respect to each of the plurality of games by referring to the complex information storage unit.

In step S360, a first preferred genre for the first member is confirmed by referring to the complex information storage unit, and a selection request message for requesting the first client terminal to select t (t is a natural number of 2 or more or less than s) additional preferred genres for recommending the customized game among the s types of genres is generated and transmitted to the first client terminal.

In step S370, when information on t first additional preferred genres among the s types of genres is received from the first client terminal in response to the selection request message, at least one first game matched with the first preferred genre and the t first additionally preferred genres is selected among the plurality of games based on the preferred genre for each of the members who play each game once or more, which is confirmed with respect to each of the plurality of games, and then recommendation information indicating that the at least one first game is a recommendation game for the first member is transmitted to the first client terminal.

In step S380, when an access request command to a tournament session (the tournament session means a session opened for allowing members accessing the tournament session through the client terminal to play the second game online jointly) opened for a second game which is any one of the one or more first games is received from the first client terminal after the recommendation information is transmitted to the first client terminal, certification for the first member is conducted, and then a first required number which is the number of required tickets for participating in the tournament of the second game is confirmed by referring to the ticket number information storage unit, and the quantity of holding tickets held by the first member is confirmed by referring to the ticket quantity information storage unit.

In step S390, when it is confirmed that the quantity of holding tickets held by the first member is equal to or more than the first required number, the first client terminal is allowed to access the tournament session, and then the quantity of holding tickets held by the first member stored in the ticket quantity information storage unit is reduced by the first required number.

In this case, according to an exemplary embodiment of the present disclosure, step S370 may include a step of maintaining a vector storage unit storing different predetermined one-hot vectors for the s types of genres, a step confirming a one-hot vector of a preferred genre for each of members who play each game once or more with respect to each of the plurality of games by referring to the vector storage unit when the t first additional preferred genres are received from the first client terminal, and aggregating all of the one-hot vectors of the preferred genres for the respective members who play each game once or more to generate an aggregation vector, and then dividing the aggregation vector by the number of members who play each game once or more to generate a game feature vector corresponding to each of the plurality of games, a step of generating k groups by performing k (k is a natural number of 3 or more)-mean clustering with respect to the plurality of games based on a game feature vector corresponding to each of the plurality of games when the game feature vector corresponding to each of the plurality of games is generated, a step of confirming the one-hot vectors for the first preferred genre and the one-hot vector for each of the t first additional preferred genres by referring to the vector storage unit when the k groups are generated, and then applying a predetermined first weight (the first weight is a rational number of more than 0 or less than 1) to the one-hot vector for the first preferred genre, and applying a predetermined second weight (the second weight as a smaller value than the first weight is the rational number of more than 0 or less than 1) to the one-hot vector for each of the t first additional preferred genres, and then aggregating both the one-hot vector for the first preferred genre and the one-hot vectors for the t first respective additional preferred genres to generate a member feature vector, a step of selecting a first group having a maximum similarity to the member feature vector among the k groups when the member feature vector is generated, and a step of selecting games belonging to the first group as the one or more first games when the first group is selected, and then transmitting, to the first client terminal, the recommendation information indicating that the at least one first game is a recommendation game for the first member.

In this case, according to an exemplary embodiment of the present disclosure, the step of selecting may include a step of computing a vector similarity between the member feature vector and a centroid vector corresponding to a centroid of each of the k groups when the member feature vector is generated, and a step of selecting, as the first group, a group having a centroid vector having a maximum vector similarity to the member feature vector among the k groups.

Further, according to an exemplary embodiment of the present disclosure, step S380 may include a step of maintaining an e-mail storage unit storing information on a predetermined e-mail address for each of the plurality of members, a step of maintaining a public key storage unit storing a public key corresponding to a private key, wherein the private key for each of the plurality of members is pre-stored in the client terminal of each member, pre-issued for each of the plurality of members, a step of generating a certification event for conducting the certification for the first member when receiving the access request command to the tournament session from the first client terminal, randomly generating, when the certification event is generated, a n (n is a natural number of 2 or more)-digit first certification number, randomly generating a certification value constituted by a natural number having a size of 9 or less, and then, a step of performing a modulo operation having the certification value as a divisor for respective digit numbers constituting the first certification number to generate an n-digit second certification number, a step of generating a column vector having respective digit numbers constituting the first certification number as components and a row vector having respective digit numbers constituting the second certification number as components, and computing a matrix multiplication between the column vector and the row vector to generate an operation matrix of an n x n size, and then computing Frobenius Norm of the operation matrix, and designating the Frobenius Norm of the operation matrix as a verification value for member certification, a step of confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value, a step of, when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n x n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and a step of completing certification for the first member when it is determined that the decryption value is equal to the Frobenius Norm of the operation matrix designated as the verification value.

Further, according to an exemplary embodiment of the present disclosure, the operating method of the service providing server may further include a step of maintaining a price information storage unit storing purchase price information of the ticket for participating in the tournament; a step of requesting, when a purchase request command for requesting purchasing tickets corresponding to a first purchase quantity is received from the first client terminal, transmitting payment means information for cost payment; a step of calculating, when first payment means information is received from the first client terminal, a price corresponding to the first purchase quantity based on the purchase price information, and then performing cost payment processing for the calculated price based on the first payment means information; and a step of increasing, when the cost payment processing is completed, the quantity of holding tickets held by the first member stored in the ticket quantity information storage unit by the first purchase quantity.

Further, according to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of confirming, when an event occurs, which indicates that the first member is a winner through the tournament session as the first member wins the tournament for the second game after the first member completes participating in the tournament for the second game as the first client terminal accesses the tournament session, a first payment amount which is the payment amount of the cryptocurrency to be paid as the reward when winning the tournament for the second game by referring to the reward information storage unit, and receiving information on a wallet address of the first member for accumulating the cryptocurrency from the first client terminal, and then transferring the cryptocurrency of the first payment amount to the wallet address of the first member to complete reward processing for the first member.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIGS. 1 to 2, a more detailed description thereof will be omitted.

An operating method of a service providing server for providing the game service that supports participation in a tournament for a game using a ticket and that recommends a customized game to a user according to an exemplary embodiment of the present disclosure may be implemented by a computer program stored in a storage medium to be executed through a combination with a computer.

Further, an operating method of a service providing server for providing the game service that supports participation in a tournament for a game using a ticket and that recommends a customized game to a user according to an exemplary embodiment of the present disclosure may be implemented as a program command form which may be performed by various computer means, and recorded in a computer-readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server for providing the game service that supports participation in a tournament for a game using a ticket and that recommends a game to a user, comprising:
a ticket number information storage unit storing information on the number of required tickets for participating in tournaments of a plurality of predetermined respective games;
a ticket quantity information storage unit storing information on the quantity of holding tickets held by each of a plurality of members which subscribes to the game service;
a complex information storage unit storing member identification information for each of the plurality of members, and information on a predetermined preferred genre corresponding to each of the plurality of members, wherein the preferred genre of each of the plurality of members means any one genre pre-selected to be a genre preferred by each member among predetermined s, wherein s is a natural number of 3 or more, types of genres;
a play history information storage unit storing play history information corresponding to each of the plurality of games, wherein the play history information of each of the plurality of games means information configured by members identification information for each of members who plays each game once or more;
a preferred genre confirmation unit conforming, when a recommendation request instruction of a customized game is received from a first client terminal held by a first member which is any one of the plurality of members, member identification information for each of members who plays each game once or more from the play history information corresponding to each of the plurality of games stored in the play history information storage unit, and then confirming a preferred genre for each of the members who play each game once or more with respect to each of the plurality of games by referring to the complex information storage unit;
a selection request message transmission unit confirming a first preferred genre for the first member by referring to the complex information storage unit, and generating and transmitting a selection request message for requesting the first client terminal to select t, wherein t is a natural number of 2 or more or less than s, additional preferred genres for recommending the customized game among the s types of genres to the first client terminal;
a recommendation information transmission unit selecting, when information on t first additional preferred genres among the s types of genres is received from the first client terminal in response to the selection request message, at least one first game matched with the first preferred genre and the t first additionally preferred genres among the plurality of games based on the preferred genre for each of the members who play each game once or more, which is confirmed with respect to each of the plurality of games, and then transmitting recommendation information indicating that the at least one first game is a recommendation game for the first member to the first client terminal;
when an access request command to a tournament session, wherein the tournament session means a session opened for allowing members accessing the tournament session through the client terminal to play the second game online jointly, opened for a second game which is any one of the one or more first games is received from the first client terminal after the recommendation information is transmitted to the first client terminal, a confirmation unit conducting certification for the first member, and then confirming a first required number which is the number of required tickets for participating in the tournament of the second game by referring to the ticket number information storage unit, and confirming the quantity of holding tickets held by the first member by referring to the ticket quantity information storage unit; and
a reduction processing unit allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number.

2. The service providing server of claim 1, wherein the recommendation information transmission unit includes
a vector storage unit storing different one-hot vectors predetermined for the s types of respective genres,
a game feature vector generation unit confirming, when the t first additional preferred genres are received from the first client terminal, the one-hot vector of the preferred genre for each of the members who play each game once or more with respect to each of the plurality of games by referring to the vector storage unit, generating the aggregation vector by aggregating all one-hot vectors of the preferred genres for the respective members who play each game once or more, and then generating a game feature vector corresponding to each of the plurality of games by dividing the aggregation vector by the number of members who play each game once or more,
a group generation unit generating, when the game feature vector corresponding to each of the plurality of games is generated, k groups by performing k, wherein k is a natural number of 3 or more, means clustering with respect to the plurality of games based on the game feature vector corresponding to each of the plurality of games,
a member feature vector generation unit confirming, when the k groups are generated, the one-hot vector for the first preferred genres and the one-hot vector for each of the t first additional preferred genres by referring to the vector storage unit, and then applying a predetermined first weight, wherein the first weight is a rational number of more than 0 and less than 1, to the one-hot vector for the first preferred genres, applying a predetermined second weight, wherein the second weight which is a smaller value than the first weight is a rational number of more than 0 and less than 1, to the one-hot vector for each of the t first additional preferred genres, and then aggregating both one-hot vectors for the first preferred genre and one hot-vectors for the t respective first additionally preferred genres to generate a member feature vector,
a group selection unit selecting, when the member feature vector is generated, a first group having a maximum similarity to the member feature vector among the k groups, and
a transmission unit selecting, when the first group is selected, games belonging to the first group as at least one first game, and then transmitting the recommendation information indicating that the at least one first game is a recommendation game for the first member, with respect to the first client terminal.

3. The service providing server of claim 2, wherein the group selection unit includes
a vector similarity computation unit computing a vector similarity between the member feature vector and a centroid vector corresponding to a centroid of each of the k groups when the member feature vector is generated, and
a selection unit selecting, as the first group, a group a centroid vector having a maximum vector similarity to the member feature vector among the k groups.

4. The service providing server of claim 1, wherein the confirmation unit includes
an e-mail storage unit storing information on a predetermined e-mail address for each of the plurality of members,
a public key storage unit storing a public key corresponding to a private key, wherein the private key for each of the plurality of members is pre-stored in the client terminal of each member, pre-issued for each of the plurality of members,
a certification event generation unit generating a certification event for conducting the certification for the first member when receiving the access request command to the tournament session from the first client terminal,
a certification information generation unit randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
a designation unit generating a column vector having respective digit numbers constituting the first certification number as components and a row vector having respective digit numbers constituting the second certification number as components, and computing a matrix multiplication between the column vector and the row vector to generate an operation matrix of an n×n size, and then computing Frobenius Norm of the operation matrix, and designating the Frobenius Norm of the operation matrix as a verification value for member certification,
an electronic signature request unit confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value,
a determination unit, when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n x n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and
a certification completion processing unit completing certification for the first member when it is determined that the decryption value is equal to the Frobenius Norm of the operation matrix designated as the verification value.

5. The service providing server of claim 1, further comprising:
a price information storage unit storing purchase price information of the ticket for participating in the tournament;
a payment means information request unit requesting, when a purchase request command for requesting purchasing tickets corresponding to a first purchase quantity is received from the first client terminal, transmitting payment means information for cost payment;
a payment processing unit calculating, when first payment means information is received from the first client terminal, a price corresponding to the first purchase quantity based on the purchase price information, and then performing cost payment processing for the calculated price based on the first payment means information; and
an increment processing unit increasing, when the cost payment processing is completed, the quantity of holding tickets held by the first member stored in the ticket quantity information storage unit by the first purchase quantity.

6. An operating method of a service providing server for providing the game service that supports participation in a tournament for a game using a ticket and that recommends a game to a user, comprising:
maintaining a ticket number information storage unit storing information on the number of required tickets for participating in tournaments of a plurality of predetermined respective games;
maintaining a ticket quantity information storage unit storing information on the quantity of holding tickets held by each of a plurality of members which subscribes to the game service;
maintaining a complex information storage unit storing member identification information for each of the plurality of members, and information on a predetermined preferred genre corresponding to each of the plurality of members, wherein the preferred genre of each of the plurality of members means any one genre pre-selected to be a genre preferred by each member among predetermined s, wherein s is a natural number of 3 or more, types of genres;
maintaining a play history information storage unit storing play history information corresponding to each of the plurality of games, wherein the play history information of each of the plurality of games means information configured by members identification information for each of members who plays each game once or more;
conforming, when a recommendation request instruction of a customized game is received from a first client terminal held by a first member which is any one of the plurality of members, member identification information for each of members who plays each game once or more from the play history information corresponding to each of the plurality of games stored in the play history information storage unit, and then confirming a preferred genre for each of the members who play each game once or more with respect to each of the plurality of games by referring to the complex information storage unit;
confirming a first preferred genre for the first member by referring to the complex information storage unit, and generating and transmitting a selection request message for requesting the first client terminal to select t, wherein t is a natural number of 2 or more or less than s, additional preferred genres for recommending the customized game among the s types of genres to the first client terminal;
selecting, when information on t first additional preferred genres among the s types of genres is received from the first client terminal in response to the selection request message, at least one first game matched with the first preferred genre and the t first additionally preferred genres among the plurality of games based on the preferred genre for each of the members who play each game once or more, which is confirmed with respect to each of the plurality of games, and then transmitting recommendation information indicating that the at least one first game is a recommendation game for the first member to the first client terminal;
when an access request command to a tournament session, wherein the tournament session means a session opened for allowing members accessing the tournament session through the client terminal to play the second game online jointly, opened for a second game which is any one of the one or more first games is received from the first client terminal after the recommendation information is transmitted to the first client terminal, conducting certification for the first member, and then confirming a first required number which is the number of required tickets for participating in the tournament of the second game by referring to the ticket number information storage unit, and confirming the quantity of holding tickets held by the first member by referring to the ticket quantity information storage unit; and
allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number.

7. The operating method of claim 6, wherein the selecting at least one first game includes
maintaining a vector storage unit storing different one-hot vectors predetermined for the s types of respective genres,
confirming, when the t first additional preferred genres are received from the first client terminal, the one-hot vector of the preferred genre for each of the members who play each game once or more with respect to each of the plurality of games by referring to the vector storage unit, generating the aggregation vector by aggregating all one-hot vectors of the preferred genres for the respective members who play each game once or more, and then generating a game feature vector corresponding to each of the plurality of games by dividing the aggregation vector by the number of members who play each game once or more,
generating, when the game feature vector corresponding to each of the plurality of games is generated, k groups by performing k, k is a natural number of 3 or more, means clustering with respect to the plurality of games based on the game feature vector corresponding to each of the plurality of games,
confirming, when the k groups are generated, the one-hot vector for the first preferred genres and the one-hot vector for each of the t first additional preferred genres by referring to the vector storage unit, and then applying a predetermined first weight, wherein the first weight is a rational number of more than 0 and less than 1, to the one-hot vector for the first preferred genres, applying a predetermined second weight, wherein the second weight which is a smaller value than the first weight is a rational number of more than 0 and less than 1, to the one-hot vector for each of the t first additional preferred genres, and then aggregating both one-hot vectors for the first preferred genre and one hot-vectors for the t respective first additionally preferred genres to generate a member feature vector,
selecting, when the member feature vector is generated, a first group having a maximum similarity to the member feature vector among the k groups, and
selecting, when the first group is selected, games belonging to the first group as at least one first game, and then transmitting the recommendation information indicating that the at least one first game is a recommendation game for the first member, with respect to the first client terminal.

8. The operating method of claim 7, wherein the selecting a first group includes
computing a vector similarity between the member feature vector and a centroid vector corresponding to a centroid of each of the k groups when the member feature vector is generated, and
selecting, as the first group, a group a centroid vector having a maximum vector similarity to the member feature vector among the k groups.

9. The operating method of claim 6, wherein the conducting certification includes
maintaining an e-mail storage unit storing information on a predetermined e-mail address for each of the plurality of members,
maintaining a public key storage unit storing a public key corresponding to a private key, wherein the private key for each of the plurality of members is pre-stored in the client terminal of each member, pre-issued for each of the plurality of members,
generating a certification event for conducting the certification for the first member when receiving the access request command to the tournament session from the first client terminal,
randomly generating, when the certification event is generated, a n, wherein n is a natural number of 2 or more, digit first certification number, randomly generating a certification value constituted by a natural number having a size of 9 or less, and then, performing a modulo operation having the certification value as a divisor for respective digit numbers constituting the first certification number to generate an n-digit second certification number,
generating a column vector having respective digit numbers constituting the first certification number as components and a row vector having respective digit numbers constituting the second certification number as components, and computing a matrix multiplication between the column vector and the row vector to generate an operation matrix of an n×n size, and then operating Frobenius Norm of the operation matrix, and designating the Frobenius Norm of the operation matrix as a verification value for member certification,
confirming a first e-mail address for the first member by referring to the e-mail storage unit, sending a certification e-mail including the first certification number with the first e-mail address as a receiving side, and then transmitting the certification value to the first client terminal, and at the same time, requesting an electronic signature based on the first certification number and the certification value,
when receiving a first electronic signature value, wherein the first electronic signature value is generated by performing, when the certification value is received in the first client terminal, and the first member inputs the first certification number included in the certification e-mail received by an account according to the first e-mail address into the first client terminal, by the first client terminal, the modulo operation having the certification value as the divisor for the respective digit numbers constituting the first certification number to generate the n-digit second certification number, and then generate a column vector having respective digit numbers constituting the first certification number as components and a row vector having respective digit numbers constituting the second certification number as components, and computing the matrix multiplication between the column vector and the row vector to generate the operation matrix of the n×n size, and then encrypting the Frobenius Norm of the operation matrix with the first private key pre-issued for the first member stored in the first client terminal, from the first client terminal in response to the electronic signature request, decrypting the first electronic signature value with a first public key corresponding to the first private key stored in the public key storage unit to generate a decryption value, and then determining whether the decryption value is equal to the Frobenius Norm of the operation matrix designated as the verification value, and
completing certification for the first member when it is determined that the decryption value is equal to the Frobenius Norm of the operation matrix designated as the verification value.

10. The operating method of claim 6, further comprising:
maintaining a price information storage unit storing purchase price information of the ticket for participating in the tournament;
requesting, when a purchase request command for requesting purchasing tickets corresponding to a first purchase quantity is received from the first client terminal, transmitting payment means information for cost payment;
calculating, when first payment means information is received from the first client terminal, a price corresponding to the first purchase quantity based on the purchase price information, and then performing cost payment processing for the calculated price based on the first payment means information; and
increasing, when the cost payment processing is completed, the quantity of holding tickets held by the first member stored in the ticket quantity information storage unit by the first purchase quantity.

11. A non-transitory computer readable recording medium having a program recorded therein for allowing a computer to execute an operating method of a service providing server for providing the game service that supports participation in a tournament for a game using a ticket and that recommends a game to a user, comprising:
maintaining a ticket number information storage unit storing information on the number of required tickets for participating in tournaments of a plurality of predetermined respective games;
maintaining a ticket quantity information storage unit storing information on the quantity of holding tickets held by each of a plurality of members which subscribes to the game service;
maintaining a complex information storage unit storing member identification information for each of the plurality of members, and information on a predetermined preferred genre corresponding to each of the plurality of members, wherein the preferred genre of each of the plurality of members means any one genre pre-selected to be a genre preferred by each member among predetermined s, wherein s is a natural number of 3 or more, types of genres;
maintaining a play history information storage unit storing play history information corresponding to each of the plurality of games, wherein the play history information of each of the plurality of games means information configured by members identification information for each of members who plays each game once or more;
conforming, when a recommendation request instruction of a customized game is received from a first client terminal held by a first member which is any one of the plurality of members, member identification information for each of members who plays each game once or more from the play history information corresponding to each of the plurality of games stored in the play history information storage unit, and then confirming a preferred genre for each of the members who play each game once or more with respect to each of the plurality of games by referring to the complex information storage unit;
confirming a first preferred genre for the first member by referring to the complex information storage unit, and generating and transmitting a selection request message for requesting the first client terminal to select t, wherein t is a natural number of 2 or more or less than s, additional preferred genres for recommending the customized game among the s types of genres to the first client terminal;
selecting, when information on t first additional preferred genres among the s types of genres is received from the first client terminal in response to the selection request message, at least one first game matched with the first preferred genre and the t first additionally preferred genres among the plurality of games based on the preferred genre for each of the members who play each game once or more, which is confirmed with respect to each of the plurality of games, and then transmitting recommendation information indicating that the at least one first game is a recommendation game for the first member to the first client terminal;
when an access request command to a tournament session, wherein the tournament session means a session opened for allowing members accessing the tournament session through the client terminal to play the second game online jointly, opened for a second game which is any one of the one or more first games is received from the first client terminal after the recommendation information is transmitted to the first client terminal, conducting certification for the first member, and then confirming a first required number which is the number of required tickets for participating in the tournament of the second game by referring to the ticket number information storage unit, and confirming the quantity of holding tickets held by the first member by referring to the ticket quantity information storage unit; and
allowing, when it is confirmed that the quantity of holding tickets held by the first member is equal to or more than the first required number, the first client terminal to access the tournament session, and then reducing the quantity of holding tickets held by the first member stored in the ticket quantity information storage unit by the first required number.
